(19) United States
(12) Patent Application Publication
(10) Pub. No.: US 2021/0183182 A1
(43) Pub. Date: Jun. 17, 2021

(54) SYSTEM AND METHOD FOR PROCESSING DATA OF A MOTOR VEHICLE

(71) Applicant: MS Motorservice International GmbH, Neuenstadt Am Kocher (DE)

(72) Inventors: Joerg SEIDEL, Steinbach (DE); Sven ZEITLER, Ditzingen (DE)

(73) Assignee: MS Motorservice International GmbH, Neuenstadt Am Kocher (DE)

(21) Appl. No.: 17/048,344

(22) PCT Filed: Mar. 12, 2019
(86) PCT No.: PCT/EP2019/056150

§ 371 Date: Oct. 16, 2020

(30) Foreign Application Priority Data
Apr. 18, 2018 (DE) 10 2018 109 198.2

(51) Int. Cl. G07C 5/08; G07C 5/00

(52) U.S. Cl. CPC G07C 5/0808; G07C 5/0816; G07C 5/006; G07C 5/085; G07C 5/008

(57) ABSTRACT

A system is for processing data of a motor vehicle. In an embodiment, the system has a data processing device for processing data of the motor vehicle, an interface device for producing a data connection between the data processing device and at least one electronic component, in particular a control unit, of the motor vehicle, and a diagnostic system for processing data of the motor vehicle.

### FIELD OF THE INVENTION

The disclosure relates to a system for processing data of a motor vehicle, wherein the system comprises a data processing device for processing data of the motor vehicle.

The disclosure also relates to a method of operating such a system.

### State of the Art

Systems and methods of the type mentioned above are known and have comparatively little flexibility.

### DESCRIPTION OF THE INVENTION

It is the object of the present invention to improve a system and a method of the type mentioned above so that the above-mentioned disadvantages are reduced or avoided and utility in use is increased.

Preferred embodiments suggest a system for processing data of a motor vehicle, wherein the system comprises a data processing device for processing data of the motor vehicle, an interface device for establishing a data link between the data processing device and at least one electronic component, in particular a control unit, of the motor vehicle, and a diagnostic system for processing data of the motor vehicle. By means of the interface device an efficient data exchange between the data processing device and a component of the motor vehicle, for example a control unit of the motor vehicle, can be ensured. By providing the diagnostic system, an efficient diagnosis of, for example, faults occurring during the operation of the motor vehicle can be carried out. It is particularly advantageous that the provision of a diagnostic system allows flexible execution of a diagnosis which is not necessarily limited to the data processing device. Rather, with preferred embodiments, it may be provided that at least a part of the diagnosis or the entire diagnosis is carried out by the diagnostic system, possibly supported by the data processing device. This makes it advantageously possible to provide an efficient infrastructure for diagnosing faults in a motor vehicle and, in general, for processing data of the motor vehicle.

It is particularly advantageously conceivable with some embodiments to provide a first number of diagnostic systems for the system and a second number of data processing devices, the second number being larger, in particular substantially larger, for example by at least three orders of magnitude larger, than the first number.

The data processing device according to the embodiments can be operated, for example, by a workshop personnel of a motor vehicle repair shop and can ensure an efficient exchange of diagnostic data between the location of the repair shop and a preferably remote diagnostic system by means of a data link to at least one diagnostic system according to the embodiments. This eliminates the need to keep locally, on site in the workshop, a comparatively large amount of information that may be required for a diagnosis, or to provide correspondingly powerful data processing devices on site. Rather, a comparatively large portion of the resources required for a proper diagnosis (computing power, data or information to be provided) can be advantageously arranged in the area of the diagnostic system, and thus, can be concentrated in comparatively few locations. Accordingly, the respective requirements on the data processing device can be lower, and thus, a large number of data processing devices can be provided at comparatively low costs.

With other preferred embodiments, it is provided that the data processing device is designed as a handheld device or a mobile device. This enables efficient handling of the data processing device on site, for example in a motor vehicle repair shop.

With other preferred embodiments, it is provided that the data processing device comprises a user interface, wherein the user interface comprises in particular at least one of the following elements: a graphic user interface, an acoustic user interface, a touch-sensitive display device. This enables an efficient operation of the data processing device, in particular also by less trained or untrained personnel.

With other preferred embodiments, it is provided that the data processing device is designed as one of the following elements: smartphone, tablet computer, laptop. In this way, existing devices such as smartphones can be advantageously used to implement the functionality of the data processing device. Preferably, one or more computer programs or applications (“Apps”) may be provided to control the operation of the data processing device in a manner corresponding to the present embodiments. With regard to the diagnosis of faults, the diagnostic system according to the embodiments can be used advantageously, so that with preferred embodiments a smartphone arranged as a data processing device in the sense of the embodiments usually does not have to provide a corresponding functionality by itself.

With other preferred embodiments, it is provided that the diagnostic system comprises at least one expert system. In this way, useful knowledge, in particular knowledge of human experts, can be provided in machine-processable form for an efficient diagnosis of faults and for an evaluation of, for example, operating parameters of a motor vehicle, and can be provided for the data processing device according to the embodiments, for example.

With other preferred embodiments, it is provided that the diagnostic system is configured to execute algorithms of artificial intelligence, AI. This can significantly increase the flexibility of the system operation and the reliability of the diagnosis compared to conventional systems. While conventional systems or approaches allow, for example, a sequential processing of several fault codes or fault symptoms, the diagnostic system can execute a diagnosis much more efficiently by using AI-based algorithms, in particular, it can learn from its own operation or from information obtained during this operation (e.g. information obtained from the data processing device) and thus, can further improve its function.

With other preferred embodiments, it is provided that the data processing device is configured to read out vehicle information of the motor vehicle, in particular via the interface device, the vehicle information having at least one of the following elements: a vehicle identification number, VIN (in German: FIN, Fahrzeug-Identifizierungsnummer), identifying the motor vehicle, operating data characterizing an operation of at least one component of the motor vehicle, one or more fault codes characterizing a fault of at least one component of the motor vehicle. A comparatively low bandwidth is advantageously required for the transmission of the vehicle information.

With other preferred embodiments, the interface device may, for example, be configured to read data of the vehicle via an OBD-II interface or an interface of other type allowing the transmission of vehicle data, in particular fault codes.

With other preferred embodiments, it is provided that the data processing device is configured to transmit information, in particular vehicle information, to the diagnostic system. As already described, a comparatively low bandwidth is advantageously required to transmit the vehicle information. The vehicle information can be used in particular in the diagnostic system, for example, to carry out a component-specific and/or vehicle-specific diagnosis, and/or to build or supplement a database with the respective information, and/or to train or validate one or more AI subsystems of the diagnostic system.

With other preferred embodiments, it is provided that the diagnostic system is configured to carry out a diagnosis or to determine response information, in particular a diagnosis result and/or a repair recommendation, depending on the information, in particular the vehicle information, and to transmit it to the data processing device. Also for this, a comparatively low bandwidth is advantageously required.

With other preferred embodiments, it is provided that the diagnostic system is configured to determine the response information using artificial intelligence algorithms, depending on the information, in particular vehicle information.

With other preferred embodiments, it is provided that the data processing device and/or the diagnostic system is configured to retrieve component-specific and/or vehicle-specific information and/or other information from a database, in particular an external database. This advantageously eliminates the need to keep all the information required for a diagnosis of a large number of different vehicle types available in the diagnostic system or diagnostic device. Rather, with other preferred embodiments, these can be retrieved dynamically, i.e. in particular when required, from the external database. With other preferred embodiments, it is also conceivable to at least temporarily store the corresponding information in a (separate) database of the diagnostic system. More preferably, storage in a database of the diagnostic system can be carried out, for example, depending on a frequency of use of the respective data.

With other preferred embodiments, it is provided that at least one database is provided in the diagnostic system, in particular for storing vehicle-specific information and/or fault codes. In this way, the dependence on an external database can be reduced or an increased interference resistance for the operation of the system can be achieved.

With other preferred embodiments, it is provided that the diagnostic system is configured to at least temporarily store feedback information characterizing the course of a repair of the motor vehicle, and in particular to relate the feedback information to a previously issued repair recommendation. This advantageously in enables efficient training of the AI subsystems.

Other preferred embodiments relate to a method of operating a system for processing data of a motor vehicle, wherein the system comprises a data processing device for processing data of the motor vehicle, an interface device for establishing a data link between the data processing device and at least one electronic component, in particular a control unit, of the motor vehicle, and a diagnostic system for processing data of the motor vehicle, wherein the diagnostic system executes at least one artificial intelligence algorithm.

With other preferred embodiments, it is provided that the data processing device reads out vehicle information of the motor vehicle, in particular via the interface device, wherein the vehicle information comprises at least one of the following elements: a vehicle identification number VIN identifying the motor vehicle, operating data characterizing an operation of at least one component of the motor vehicle, one or more fault codes characterizing a fault of at least one component of the motor vehicle.

With other preferred embodiments, it is provided that the data processing device transmits information, in particular vehicle information, to the diagnostic system.

With other preferred embodiments, it is provided that the diagnostic system determines response information, in particular a diagnosis result and/or a repair recommendation, depending the information, in particular the vehicle information, and transmits it to the data processing device.

With other preferred embodiments, it is provided that the diagnostic system determines the response information using artificial intelligence algorithms, depending on the information, in particular vehicle information.

With other preferred embodiments, it is provided that the data processing device and/or the diagnostic system retrieves component-specific and/or vehicle-specific information and/or other information from a database, in particular an external database.

With other preferred embodiments, it is provided that the diagnostic system keeps a local database, in particular for storing vehicle-specific information and/or fault codes.

With other preferred embodiments, it is provided that the diagnostic system at least temporarily stores feedback information characterizing the course of a repair of the motor vehicle, and in particular relates the feedback information to a previously issued repair recommendation.

Further features, possible applications and advantages of the invention are set out in the following description of exemplary embodiments of the invention, which are shown in the figures of the drawings. All described or depicted features, on their own or in any combination, form the subject-matter of the invention, irrespective of their combination in the claims or their references, and irrespective of their formulation or representation in the description or in the drawings.

In the drawings:

FIG. 1 schematically shows a simplified block diagram of a system according to an embodiment,

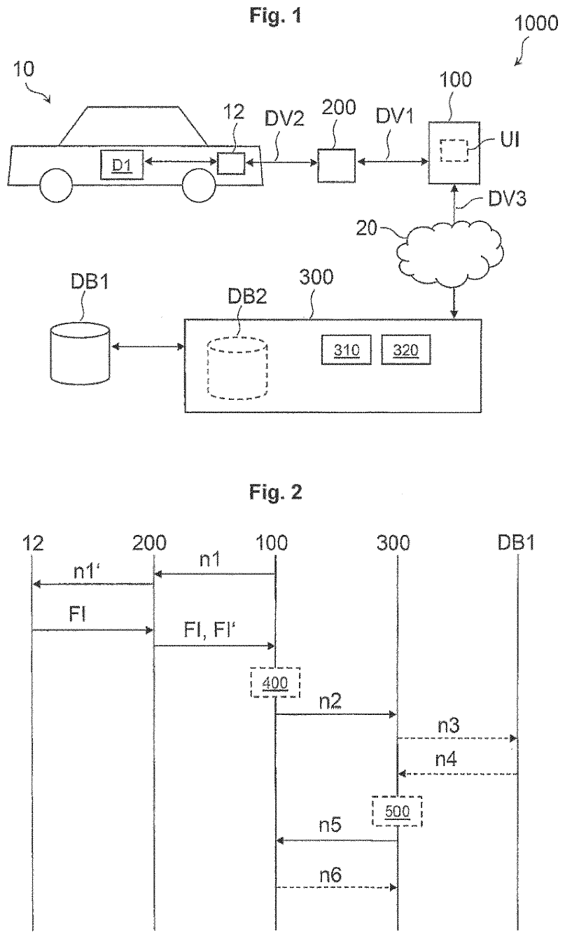

FIG. 2 schematically shows a simplified flow chart according to an embodiment, and

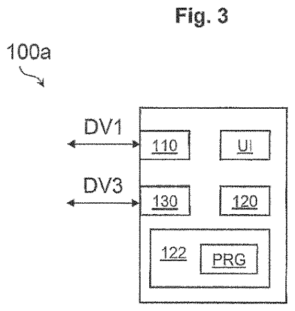

FIG. 3 schematically shows a simplified block diagram of a data processing device according to an embodiment.

FIG. 1 schematically shows a simplified block diagram of a system 1000 according to an embodiment. System 1000 comprises a data processing device 100 for processing data D1 of a motor vehicle 10. For example, data D1 comprises operating parameters and/or fault codes of an ECU 12 of motor vehicle 10. Alternatively or additionally, data D1 may also include operating parameters and/or fault codes and/or other data of at least one other system (not shown) of motor vehicle 10.

System 1000 also includes an interface device 200 for establishing a data link between data processing device 100 and control unit 12. The data link is preferably a wireless or cable-free data link, at least as far as the first part DV1 of the data link is concerned, which is for example designed as a Bluetooth connection and/or WLAN connection or the like. The second part DV2 of the data link can, for example, also be wired and/or designed by means of an electrical plug connection, or also wireless. With preferred embodiments, interface device 200 can be designed in the form of a so-called OBD-II dongle, for example, which is connectable to an OBD-II interface of motor vehicle 10 in a manner known per se and can thus be brought into data connection with control unit 12, for example.

For simple and efficient control of the operation of data processing device 100, the same is provided with a user interface UI which may in particular include a graphic user interface and/or an acoustic user interface.

With preferred embodiments, data-processing device 100 is designed as a hand-held and/or mobile device, in particular with a touch-sensitive display device (not shown), which enables easy handling.

With particularly preferred embodiments, data processing device 100 is designed as one of the following elements: Smartphone, tablet computer, laptop.

System 1000 also comprises a diagnostic system 300 for processing data from motor vehicle 10. Diagnostic system 300 is preferably connectable to data processing device 100 via a wireless data link DV3, possibly also with the interposition of one or more private and/or public networks 20 (Internet). For example, in other preferred embodiments, wireless data link DV3 can also be implemented using a cellular mobile radio system of the third and/or fourth and/or fifth generation (3G, 4G (e.g. LTE), 5G).

With preferred embodiments, diagnostic system 300 comprises at least one expert system 310, which enables an efficient diagnosis by diagnostic system 300. In other preferred embodiments, diagnostic system 300 is configured to execute algorithms of artificial intelligence, AI. For this purpose, for example, at least one AI subsystem 320 can be provided, which comprises one or more artificial neural networks and/or other elements from the field of artificial intelligence, for example.

With other preferred embodiments, diagnostic system 300 is configured to access an external database DB1, in particular to retrieve vehicle-specific information or component-specific information relating to a component of motor vehicle 10, for example.

With preferred embodiments, diagnostic system 300 can also comprise its own, preferably local, database DB2.

With other preferred embodiments, data processing device 100 is configured to read out vehicle information of motor vehicle 10, in particular via interface device 200, wherein the vehicle information comprises at least one of the following elements: a vehicle identification number VIN identifying motor vehicle 10, operating data characterizing an operation of at least one component of motor vehicle 10, one or more fault codes characterizing a fault of at least one component of motor vehicle 10.

With other preferred embodiments, data processing device 100 is configured to transmit information, in particular vehicle information, to diagnostic system 300.

With other preferred embodiments, diagnostic system 300 is configured to determine response information, in particular a repair recommendation, depending on the information, in particular vehicle information, and to transmit it to data processing device 100.

With other preferred embodiments, diagnostic system 300 is configured to determine the response information using artificial intelligence algorithms, depending on the information, especially the vehicle information.

With other preferred embodiments, data processing device 100 is configured to retrieve component-specific and/or vehicle-specific information and/or other information from a database, in particular external database DB1.

With other preferred embodiments, at least one database DB2 is provided in diagnostic system 300, in particular for storing vehicle-specific information and/or fault codes.

With other preferred embodiments, diagnostic system 300 is configured to at least temporarily store feedback information characterizing the course (e.g. cost and/or success and/or duration) of a repair of the motor vehicle, and in particular to relate the feedback information to a previously issued repair recommendation. With further embodiments, this information can be advantageously used by diagnostic system 300 for the adaptation, in particular the improvement, of its algorithms, in particular its AI-based algorithms.

FIG. 2 schematically shows a simplified flowchart of a method according to an embodiment. Data processing device 100 transmits a first message n1 to interface device 200 (for example an OBD-II dongle which is in data connection DV1, DV2 with control unit 12 (FIG. 1) of motor vehicle 10), and interface device 200 forwards the first message n1 in the form of message n1′ to control unit 12 (for example via the OBD-II interface of motor vehicle 10). The first message n1, n1′ may, for example, contain a control command which causes control unit 12 to output vehicle information FI to interface device 200 and/or data processing device 100. Vehicle information FI may comprise, for example, fault codes typically stored in fault memories of one or more control units 12 of motor vehicle 10. Alternatively or additionally, vehicle information FI may contain one or more of the data already mentioned above (vehicle identification number and the like). With some embodiments, interface device 200 may, for example, transmit vehicle information FI substantially unchanged to data processing device 100. With other embodiments, it may be provided that interface device 200 filters and/or otherwise processes or treats vehicle information FI received from control unit 12 in order to transmit the thus obtained filtered and/or processed vehicle information FI to data processing device 100.

With preferred embodiments, data processing device 100 can carry out a local processing of the received vehicle information FI, FI′, such as further filtering and/or other processing, cf. the optional step 400 according to FIG. 2.

Data processing device 100 can also transmit the received vehicle information FI, FI′ or data derived therefrom to diagnostic system 300, for example in the form of a second message n2 (e.g. via data link DV3, FIG. 1). If diagnostic system 300 requires further data to carry out a diagnosis with regard to the data of the second message n2, for example vehicle-specific information and/or component-specific information and the like, diagnostic system 300 can query or retrieve this data from external database DB1 by means of message n3. After receiving a corresponding response with the requested data from database DB1, cf. further message n4, diagnostic system 300 can carry out a diagnosis, cf. optional step 500. As a result of diagnosis 500, for example, a diagnosis result can be obtained. With preferred embodiments, this is done in particular by using at least one artificial intelligence algorithm, for example by means of at least one AI subsystem 320, cf. FIG. 1.

After the execution 500 of the diagnosis, diagnostic system 300 can transmit a further message n5 to data processing device 100, which may e.g. contain the diagnosis result and/or a repair recommendation. For example, such a repair recommendation may contain an indication for a user of data processing device 100, which specifies which component of motor vehicle 10 (FIG. 1) is to be replaced preferentially in order to enable an efficient repair, i.e. elimination of fault causes of the motor vehicle.

With the principle according to the embodiments, an efficient diagnosis can be carried out advantageously, wherein particularly preferably a comparatively small first number of diagnostic systems 300 enables the powerful provision of an AI-based efficient diagnosis for a comparatively large second number of data processing devices 100.

With other embodiments, it may be provided that diagnostic system 300 at least temporarily stores feedback information characterizing a course of a repair of the motor vehicle, and in particular relates the feedback information to a previously issued repair recommendation n5. With other embodiments, such feedback information can be transmitted to diagnostic system 300, for example by data processing device 100, by means of a further optional message n6, for example depending on a user input from a user of data processing device 100, which rates an effect or a quality of the repair recommendation n5.

FIG. 3 schematically shows a simplified block diagram of a data processing device 100a according to an embodiment. For example, data processing device 100 according to FIG. 1, 2 may have the configuration shown in FIG. 3. Data processing device 100a comprises a first data interface 110 for establishing first data link DV1 (for example, Bluetooth and/or WLAN or the like) and a second data interface 130 for establishing data link DV3 to diagnostic system 300.

Data processing device 100a further comprises a computing device 120, which for example comprises at least one microcontroller and/or microprocessor and/or digital signal processor (DSP), and/or a programmable logic device (FPGA, field programmable gate array) and/or an application-specific integrated circuit (ASIC). Computing device 120 is assigned a memory device 122 which is configured to at least temporarily store a computer program PRG. Computer program PRG can, for example, be configured to execute the method according to the embodiments. Memory device 122 can comprise at least one volatile memory, for example, in particular working memory (RAM), and/or at least one non-volatile memory, in particular read-only memory (ROM) and/or flash EEPROM memory or the like.

Computing device 120 is also particularly preferably configured to provide a user interface UI, in particular a graphic user interface, for at least one user of data processing device 100a. In this way, diagnosis and/or repair instructions can be efficiently provided for the user, which, for example, can be kept in memory device 122 at least temporarily and/or can be retrieved by diagnostic system 300 as required.

With other preferred embodiments, it may be provided that component-specific and/or vehicle-specific data, which in particular comprises information up to a component level, is stored in first database DB1 (FIG. 1) and/or second database DB2. Preferably, the vehicle-specific data comprises a linkage between components of the same component type and data from different vehicle manufacturers.

The system according to the embodiments is not limited to the processing of data of a motor vehicle, but can also be used to process data of other vehicles.

1. A system for processing data of a motor vehicle, wherein the system comprises:
a data processing device for processing data of the motor vehicle;
an interface device for establishing a data link between the data processing device; and
at least one electronic component; wherein the system further comprises
a diagnostic system for processing the data of the motor vehicle.

2. The system of claim 1, wherein the data processing device is designed as a handheld device or mobile device.

3. The system of claim 1, wherein the data processing device includes a user interface, the user interface including at least one of a graphic user interface and an acoustic user interface.

4. The system of claim 1, wherein the data processing device is designed as one of a smartphone, a tablet computer, and a laptop.

5. The system of claim 1, wherein the diagnostic system comprises at least one expert system.

6. The system of claim 1, wherein the diagnostic system is configured to execute algorithms of artificial intelligence.

7. The system of claim 1, wherein the data processing device is configured to read out vehicle information of the motor vehicle, and wherein the vehicle information comprises at least one of: a vehicle identification number identifying the motor vehicle, operating data characterizing an operation of at least one component of the motor vehicle, and one or more fault codes characterizing a fault of at least one component of the motor vehicle.

8. The system of claim 1, wherein the data processing device is configured to transmit information to the diagnostic system.

9. The system of claim 1, wherein the diagnostic system is configured to determine response information, depending on the information, and to transmit the response information to the data processing device.

10. The system of claim 9, wherein the diagnostic system is configured to determine the response information using artificial intelligence algorithms, depending on the information.

11. The system of claim 1, wherein at least one of the data processing device and the diagnostic system is configured to retrieve at least one of component-specific information, vehicle-specific information and other information from a database.

12. The system of claim 1, wherein at least one database is provided in the diagnostic system for storing at least one of vehicle-specific information and fault codes.

13. The system of claim 1, wherein the diagnostic system is configured to at least temporarily store feedback information characterizing a course of a repair of the motor vehicle.

14. A method of operating a system for processing data of a motor vehicle, wherein the system comprises a data processing device for processing data of the motor vehicle, an interface device for establishing a data link between the data processing device and at least one electronic component of the motor vehicle, and a diagnostic system for processing data of the motor vehicle, wherein the diagnostic system processes data of the motor vehicle.

15. The method of claim 14, wherein the data processing device reads out vehicle information of the motor vehicle, wherein the vehicle information comprises at least one of: a vehicle identification number identifying the motor vehicle, operating data characterizing an operation of at least one component of the motor vehicle, and one or more fault codes characterizing a fault of at least one component of the motor vehicle.

16. The method of claim 14, wherein the data processing device transmits vehicle information to the diagnostic system.

17. The method of claim 14, wherein the diagnostic system determines response information, depending on the information, and transmits the response information to the data processing device.

18. The method of claim 17, wherein the diagnostic system determines the response information using artificial intelligence algorithms, depending on the vehicle information.

19. The method of claim 14, wherein at least one of the data processing device and the diagnostic system retrieves at least one of component-specific information, vehicle-specific information and other information from an external database.

20. The method of claim 14, wherein the diagnostic system keeps a local database for storing at least one of vehicle-specific information and fault codes.

21. The method of claim 14, wherein the diagnostic system at least temporarily stores feedback information characterizing a course of a repair of the motor vehicle, and relates the feedback information to a previously issued repair recommendation.

22. The system of claim 1, wherein the response information includes at least one of a diagnosis result and a repair recommendation, and wherein the information includes vehicle information.

23. The system of claim 13, wherein the diagnostic system is configured to relate the feedback information to a previously issued repair recommendation.
